(19) United States
(12) Patent Application Publication
(10) Pub. No.: US 2015/0168060 A1
(43) Pub. Date: Jun. 18, 2015

(54) CONTROL METHOD OF FABRIC TREATMENT APPARATUS

(71) Applicant: LG ELECTRONICS INC., Seoul (KR)

(72) Inventors: Minji KIM, Seoul (KR); Sungho SONG, Seoul (KR); Hyukjin AHN, Seoul (KR)

(21) Appl. No.: 14/568,979

(22) Filed: Dec. 12, 2014

(30) Foreign Application Priority Data
Dec. 12, 2013 (KR) 10-2013-0154955

(51) Int. Cl. F26B 3/02; F26B 21/10

(52) U.S. Cl. CPC F26B 3/02; F26B 21/10

(57) ABSTRACT

A control method of a fabric treatment apparatus including supplying high-temperature hot air into a treatment space of the function treatment apparatus, in which fabric is treated, through operation of a drying heater, sensing a temperature of the treatment space, and spraying steam into the treatment space through a steam spray device when the sensed temperature of the treatment space is equal to or greater than a set temperature.

### CROSS-REFERENCE TO RELATED APPLICATION

This application claims priority under 35 U.S.C. §119 to Korean Application No. 10-2013-0154955, filed Dec. 12, 2013, the subject matter of which is hereby incorporated by reference.

### BACKGROUND

1. Field

The present disclosure relates to a control method of a fabric treatment apparatus.

2. Background

A fabric treatment apparatus, which is an apparatus for treating fabric, may be classified as a washer for removing contaminants from fabric using water and detergent, a dryer for applying hot air or cold air to wet fabric to dry the fabric, or a refresher for spraying water to fabric in the form of steam or mist to unwrinkle or deodorize the fabric and thus to manage the fabric in a more comfortable state. In recent years, complex apparatuses, such as a combination dryer and washer, and a washer or a dryer having a refreshing function, capable of complexly performing functions of the above-mentioned apparatuses, have also been widely used.

For a fabric treatment apparatus having a drying function, however, the temperature of the fabric is steadily increased as drying of the fabric is progressed, potentially resulting in over drying. Particularly for a fabric treatment apparatus that dries fabric while a drum, in which the fabric is placed, is rotated, moisture may be removed from the fabric and thus the volume of the fabric may be increased as drying of the fabric is progressed. When the amount of the fabric is large, the fabric may not be uniformly mingled. Consequently, the temperature of fabric placed near a hot air discharge port may be excessively increased and thus more moisture than necessary removed from the fabric or the fabric may shrink, may be discolored, or may be denaturalized due to rapid removal of the moisture or overheating.

### SUMMARY

One object is to provide a control method of a fabric treatment apparatus that is capable of preventing the temperature of fabric from being excessively increased during drying of the fabric.

In accordance with an embodiment of the present invention, the above and other objects can be accomplished by the provision of a control method of a fabric treatment apparatus having a drying function, the control method including supplying, by a drying heater and a blower, high-temperature hot air into a treatment space of the fabric treatment apparatus, through operation of a drying heater, sensing, by a temperature sensor, a temperature of the treatment space, and spraying steam, by a steam spray device, into the treatment space through a steam spray device when the sensed temperature of the treatment space is equal to or greater than a set temperature.

The step of spraying the steam may include spraying the steam for a predetermined time period.

The step of spraying the steam may include intermittently spraying the steam through the steam spray device until a predetermined drying completion condition is satisfied. The step of intermittently spraying the steam may include spraying the steam for 10 to 20 seconds every 2 to 3 minutes.

The control method may further include stopping, by a controller, the operation of the drying heater when the sensed temperature of the treatment space is equal to or greater than the set temperature, wherein the steam spray device may include a steam generation heater for generating steam, and wherein the step of spraying the steam may include operating the steam generation heater for a predetermined time. The control method may further include stopping, by a controller, the operation of the steam generation heater after a predetermined period of time and operating, by the controller, the drying heater again after the operation of the steam generation heater is stopped.

The set temperature may be about 65° C.

The set temperature may be about 75° C.

The step of supplying hot air may include operating, by a controller, a blower for blowing air into the treatment space during the operation of the drying heater.

The fabric treatment apparatus may include a rotatable drum defining the treatment space, and the step of supplying the hot air may include rotating, by a motor, the drum such that the fabric is tumbled in the drum.

In accordance with another embodiment of the present invention, there is provided a fabric treatment apparatus including a treatment space forming unit having a treatment space, in which fabric is treated, a drying heater for heating air to be supplied to the treatment space, a blower for blowing the air heated by the drying heater to the treatment space, a temperature sensor for sensing a temperature of the treatment space, a steam spray device for spraying steam to the treatment space, and a controller for controlling the drying heater and the blower to supply high-temperature hot air to the treatment space and for controlling the steam spray device to spray steam when the temperature of the treatment space sensed by the temperature sensor reaches a set temperature.

The controller may control the steam spray device to spray the steam for a predetermined period of time.

The controller may control the steam spray device to intermittently spray the steam until a predetermined drying completion condition is satisfied. The controller may control the steam spray device to spray the steam for 10 to 20 seconds every 2 to 3 minutes.

The steam spray device may include a steam generation heater for generating steam, and the controller may control the operation of the drying heater to be stopped and the steam generation heater to be operated for a predetermined period of time when the temperature of the treatment space sensed by the temperature sensor reaches the set temperature. The controller may control the operation of the steam generation heater to be stopped and the drying heater to be operated again after an elapse of the predetermined time.

The set temperature may be about 65° C.

The set temperature may be about 75° C. The fabric treatment apparatus may further include an input unit for allowing selective input of a normal drying mode or a high-temperature drying mode, wherein the set temperature when the high-temperature drying mode is selected through the input unit may be higher than the set temperature when the normal drying mode is selected through the input unit.

The treatment space forming unit may include a rotatable drum, in which fabric is received, and the controller may control the drum to be rotated such that the fabric is tumbled in the drum during supplying of high-temperature hot air to the treatment space.

### BRIEF DESCRIPTION OF THE DRAWINGS

Embodiments will be described in detail with reference to the following drawings in which like reference numerals refer to like elements, and wherein:

FIG. 1 is a perspective view showing a dryer according to an embodiment of the present invention;

FIG. 2 is a sectional view taken along line A-A of FIG. 1;

FIG. 3 is an exploded perspective view showing the dryer according to the embodiment of the present invention;

FIG. 4 is a perspective view showing the interior of the dryer including a spray device;

FIG. 5 is a view showing an embodiment of the spray device;

FIG. 6 is a block diagram showing a control system of the dryer according to the embodiment of the present invention;

FIG. 7 is a flowchart showing a control method of a dryer according to an embodiment of the present invention;

FIG. 8 is a flowchart showing a control method of a dryer according to another embodiment of the present invention;

FIG. 9 is a flowchart showing a control method of a dryer according to a further embodiment of the present invention;

FIG. 10 is a graph showing a comparison between a shrinkage rate (b) of fabric based on materials of the fabric in a normal drying mode of a dryer according to an embodiment of the present invention and a shrinkage rate (a) of fabric in a conventional dryer; and

FIG. 11 is a graph showing a comparison between a shrinkage rate (b′) of fabric based on materials of the fabric in a high-temperature drying mode of the dryer according to the embodiment of the present invention and a shrinkage rate (a′) of fabric in the conventional dryer.

### DETAILED DESCRIPTION

Advantages and features of the invention, and methods for achieving the same may become apparent upon referring to the embodiments described later in detail together with attached drawings. However, embodiments are not strictly limited as disclosed hereinafter, but may be embodied in different modes. The same reference numbers may refer to the same elements throughout the specification.

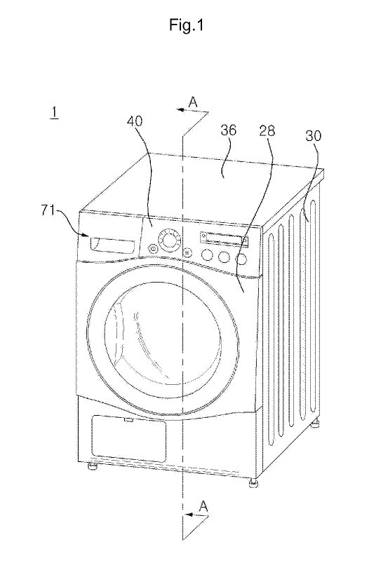

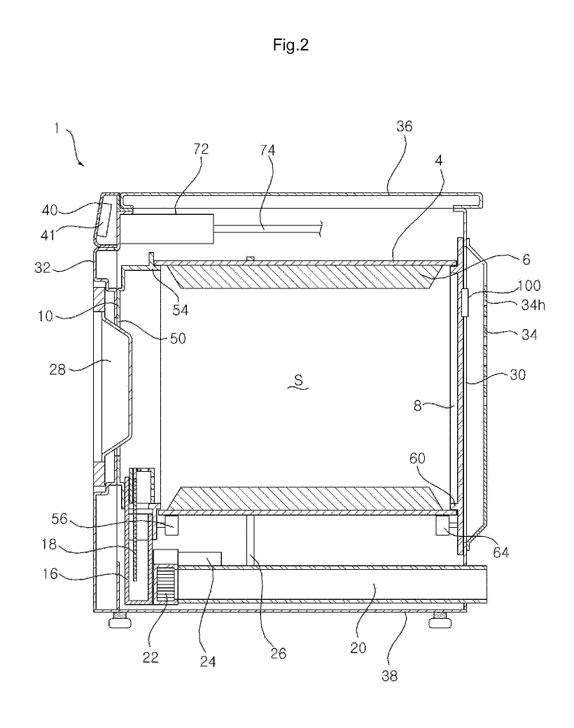

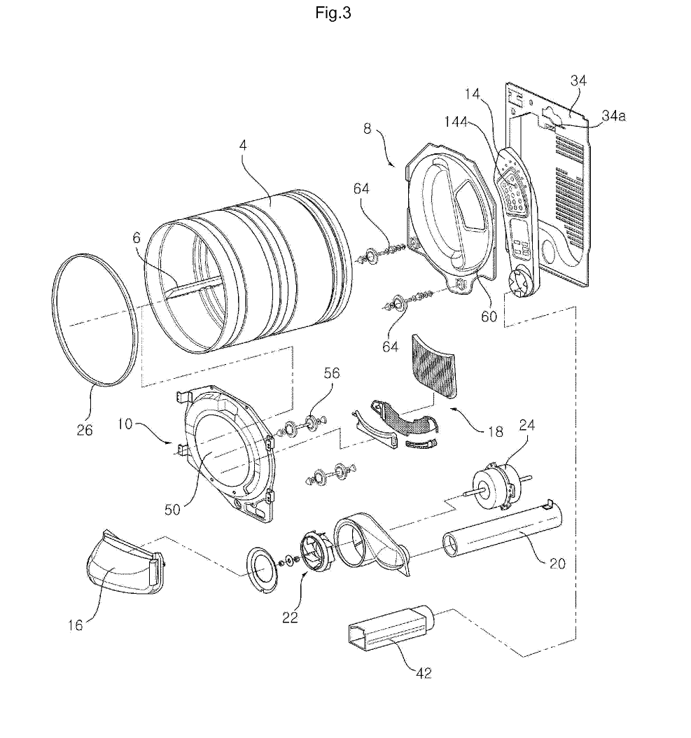

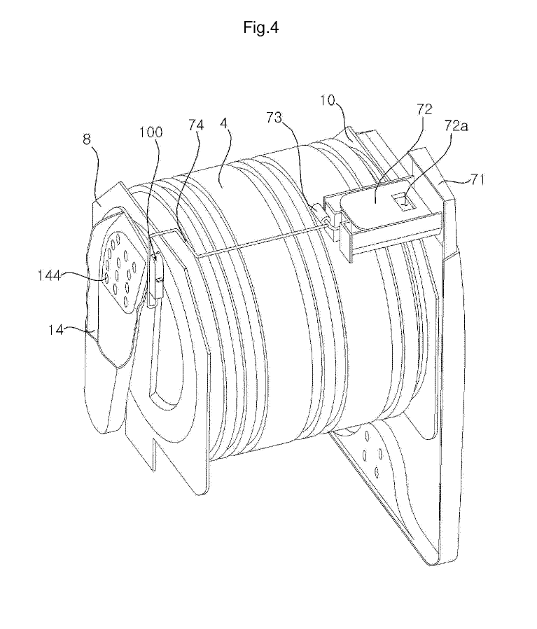

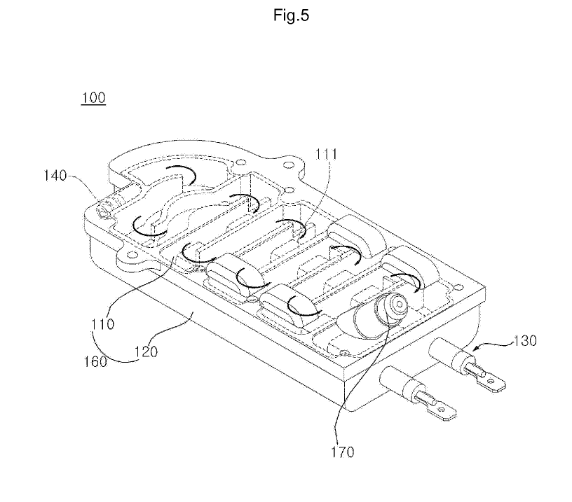

FIG. 1 is a perspective view showing a dryer according to an embodiment of the present invention. FIG. 2 is a sectional view taken along line A-A of FIG. 1. FIG. 3 is an exploded perspective view showing the dryer according to the embodiment of the present invention. FIG. 4 is a perspective view showing the interior of the dryer including a spray device. FIG. 5 is a view showing an embodiment of the spray device.

Referring to FIGS. 1 to 4, a dryer 1 according to an embodiment of the present invention includes a treatment space forming unit having a treatment space S, in which fabric is treated, formed therein. The treatment space forming unit may include a drum 4 rotatably disposed therein. Hereinafter, the treatment space forming unit will be described as drum 4 by way of example; however, the present invention is not limited thereto. According to rotation of drum 4, the position of fabric may be changed. In particular, the fabric may be lifted and then dropped by lifters 6 disposed at the inner circumference of drum 4.

A casing, which forms the external appearance of dryer 1, may include a cabinet 30, a cabinet cover 32 mounted at the front of cabinet 30, the cabinet cover 32 including a laundry introduction port at the middle thereof, a control panel 40 provided at the upper side of cabinet cover 32, a back panel 34 mounted at the rear of cabinet 30, the back panel 34 having at least one through-hole 34h through which air flows into and out of cabinet 30, a top plate 36 for covering the upper part of cabinet 30, and a base 38 mounted at the lower part of cabinet 30. A door 28 for opening and closing the laundry introduction port may be hingedly connected to the cabinet cover 32.

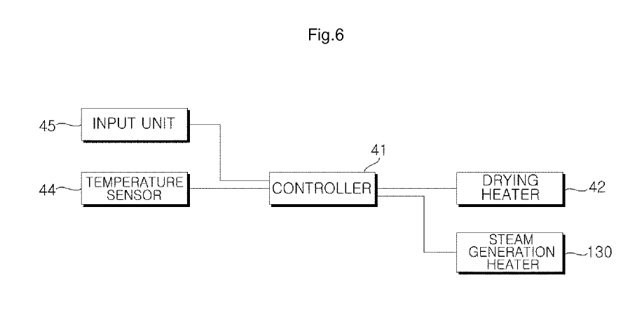

Control panel 40 may be provided at the front of dryer 1 and includes an input unit 45 (see FIG. 6), such as a button and/or dial, for allowing a user to input various control commands related to operation of dryer 1 and a display unit (not shown), such as a liquid crystal display (LCD) and/or a light emitting diode (LED), for visually displaying operation status of dryer 1. Control panel 40 may be provided at the rear of dryer 1 and further includes a controller 41 (see FIG. 6) for controlling overall operation of dryer 1. In particular, a normal drying mode or a high-temperature drying mode may be selected through input unit 45. The controller 41 may comprise hardware (e.g., a microprocessor).

Dryer 1 may be provided with a container 72 for supplying water to a steam spray device 100 such that container 72 can be withdrawn from dryer 1. A drawer 71 may be supported by cabinet 30 such that drawer 71 can be withdrawn from dryer 1 and container 72 may be received in drawer 71. Container 72 may have a water supply port 72a, through which water is introduced into the container 72.

The casing is provided at the front part and the rear part thereof with a front supporter 10 and a rear supporter 8, respectively. The front and the rear of drum 4 are supported by front supporter 10 and rear supporter 8, respectively.

Front supporter 10 includes an opening 50 provided at the middle of front support 10 and in communication with the laundry introduction part. Front supporter 10 is further provided at the rear thereof with a ring-shaped front support protrusion 54 for supporting a front end of drum 4. In addition, front supporter 10 is provided at the lower part thereof with a front guide roller 56 which is rotatable. The inner circumference of the front end of drum 4 is supported by front support protrusion 54 and the outer circumference of the front end of drum 4 is supported by front guide roller 56.

Rear supporter 8 is provided at the front thereof with a ring-shaped rear support protrusion 60 for supporting a rear end of drum 4 and rear supporter 8 is provided at the lower part of the front thereof with a rear guide roller 64 which is rotatable. The inner circumference of the rear end of drum 4 is supported by rear support protrusion 60 and the outer circumference of the rear end of drum 4 is supported by rear guide roller 64.

Drum 4 is provided at a lower side thereof with a drying heater 42 for heating air. A drying duct 14 is provided between rear supporter 8 and drying heater 42 such that rear supporter 8 and drying heater 42 communicate with each other via drying duct 14 for supplying the air heated by drying heater 42 into drum 4. Front supporter 10 is provided with a lint duct 16 such that lint duct 16 communicates with front supporter 10 for allowing the air having passed through drum 4 to be introduced thereinto.

Drying duct 14 is provided with a plurality of through holes 144, through which air is discharged into drum 4. Air flows in drum 4 via lint duct 16, a blower 22, and an exhaust duct 20 due to the blowing force generated by blower 22. Particularly, in the flowing process of the air, the air heated by drying heater 42 flows along drying duct 14 and is then discharged into drum 4 through the through holes 144.

Additionally, the air introduced into lint duct 16 is purified by a filter 18. The casing is provided at the rear thereof with an exhaust duct 20 for guiding the air from lint duct 16 to the outside of the casing.

Blower 22 is connected between exhaust duct 20 and lint duct 16. Dryer 1 further includes a motor 24 for generating the driving force of blower 22. A transmission belt 26 interlocked with the motor 24 rotates drum 4.

Referring to FIG. 5, steam spray device 100 includes a flow channel forming unit 160 having a flow channel, along which water introduced through an introduction port 140 is guided to a nozzle 170, formed therein. A steam generation heater 130 for applying heat to the water flowing along the flow channel is provided in flow channel forming unit 160. Nozzle 170 sprays steam generated by a heating operation of steam generation heater 130 at a predetermined pressure.

Flow channel forming unit 160 may include a flow channel body 110 having a flow channel 111, along which water is guided from introduction port 140 to nozzle 170, formed therein. The flow channel body 110 being open at the upper part thereof, and a cover 120 for covering the open upper part of flow channel body 110. According to embodiments, flow channel body 110 and cover 120 may be integrally formed. Introduction port 140, which is connected to a water supply pipe 74, is formed at the flow channel body 110. Consequently, water is introduced into flow channel body 110 through introduction port 140.

Flow channel forming unit 160 and nozzle 170 may be integrally coupled to each other. Integral coupling between flow channel forming unit 160 and nozzle 170 includes a case in which flow channel forming unit 160 and nozzle 170 are formed as separate members and are then coupled to each other to constitute a single unit or module and a case in which flow channel forming unit 160 and nozzle 170 are formed as a single member by injection molding. The position of nozzle 170 may be decided based on the fixed position of flow channel forming unit 160.

In a conventional structure in which water contained in a predetermined container is heated to generate steam and the generated steam is fed to a nozzle along a hose, the stream is condensed during flowing of the steam along the hose. As a result, the condensed water is sprayed through the nozzle, whereby fabric is wetted. In this embodiment of the present invention, on the other hand, water is heated to generate steam during flowing of the water along flow channel forming unit 160, the steam is sprayed through nozzle 170 integrally formed at the flow channel forming unit 160. Consequently, it is possible to fundamentally prevent the occurrence of a phenomenon in which the steam generated in flow channel forming unit 160 is condensed while being supplied to nozzle 170.

Referring to FIG. 6, dryer 1 may include a controller 41 and a temperature sensor 44 in addition to input unit 45, drying heater 42, and steam generation heater 130.

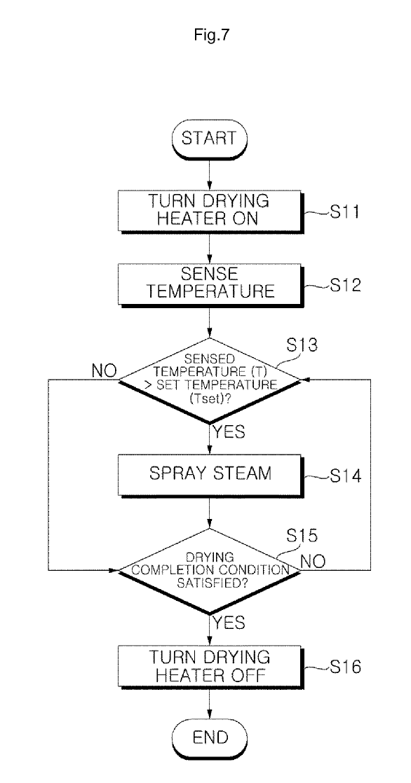

Temperature sensor 44 senses the temperature of air in the treatment space, i.e. drum 4. Controller 41 controls operations of the respective components of dryer 1 and, additionally, controls the operation of drying heater 42 and/or steam generation heater 130 based on the temperature sensed by temperature sensor 44. Control methods of a fabric treatment apparatus according to embodiments of the present invention described hereinafter with reference to FIGS. 7 to 9 is based on control of controller 41 unless mentioned otherwise.

Control methods of a fabric treatment apparatus (for example, a dryer) according to embodiments of the present invention described hereinafter each include a hot air supplying step of supplying high-temperature hot air into treatment space S, in which fabric is treated, through the operation of drying heater 42, a temperature sensing step of sensing the temperature of treatment space S, and a steam spraying step of spraying steam into treatment space S through steam spray device 100 when the sensed temperature of treatment space S is equal to or greater than a set temperature. Hereinafter, the control methods of the fabric treatment apparatus will be described in more detail with reference to the accompanying drawings.

FIG. 7 is a flowchart showing a control method of a dryer according to an embodiment of the present invention. Referring to FIG. 7, dryer 1 supplies hot air into drum 4 to dry fabric (S11). At step S11, drying heater 42 is operated and blower 22 is rotated. During supply of the hot air, drum 4 may be rotated. At this time, drum 4 may be rotated at a speed at which the fabric can be lifted to a predetermined height and then dropped, i.e. tumbled.

During supply of the hot air, the temperature of air in drum 4 is sensed by temperature sensor 44 (S12). In the following description, sensing of temperature by temperature sensor 44 is continuously carried out until the drying of the fabric is completed.

When a temperature T sensed by temperature sensor 44 is equal to or greater than a set temperature Tset (S13), controller 41 controls steam spray device 100 to spray steam for a predetermined time (S14).

Subsequently, controller 41 compares the temperature T sensed by temperature sensor 44 with the set temperature Tset until a drying completion condition is satisfied to control the operation of steam spray device 100 (S15->S13->S14). The drying completion condition may be a time passed after drying heater 42 starts to be operated or determination as to whether humidity in drum 4 is lowered to a predetermined level. In the latter case, dryer 1 may further include a humidity sensor (not shown) form sensing the humidity in drum 4. Alternatively, dryer 1 may further include at least one temperature sensor provided in the hot air flow channel so as to estimate the humidity in drum 4 based on a difference from the temperature sensed by temperature sensor 44.

At step S14, the steam may be sprayed for a predetermined time. For example, the steam may be sprayed for 10 to 20 seconds; however, the present invention is not limited thereto.

When the drying completion condition is satisfied at step S15, the operation of drying heater 42 is stopped (S16) and drying of the fabric is completed.

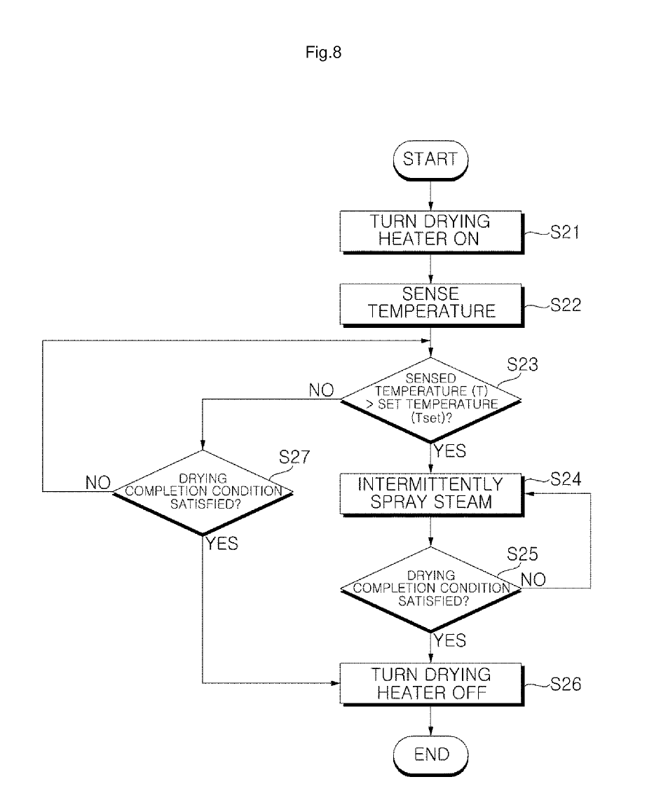

FIG. 8 is a flowchart showing a control method of a dryer according to another embodiment of the present invention. Referring to FIG. 8, dryer 1 supplies hot air into drum 4 to dry the fabric (S21). At step S21, drying heater 42 is operated and blower 22 is rotated. During supply of the hot air, drum 4 may be rotated. At this time, drum 4 may be rotated at a speed at which the fabric can be tumbled.

During supply of the hot air, the temperature of air in drum 4 is sensed by temperature sensor 44 (S22). When a temperature T sensed by temperature sensor 44 is equal to or greater than a set temperature Tset (S23), controller 41 controls steam spray device 100 to intermittently spray steam (S24). Steam spray device 100 may spray steam for a predetermined time, stop the spraying of steam, and then spray steam again, a process which may be repeated. For example, steam may be sprayed for 10 to 20 seconds every 2 to 3 minutes. Spraying of the steam (S24) is continued until the drying completion condition is satisfied (S25). When the drying completion condition is satisfied at step S25, the operation of drying heater 42 is stopped (S26) and drying of the fabric is completed.

On the other hand when the temperature T sensed by temperature sensor 44 is lower than the set temperature Tset at step S23 and the drying completion condition is not satisfied at step S27, the procedure returns to step S23.

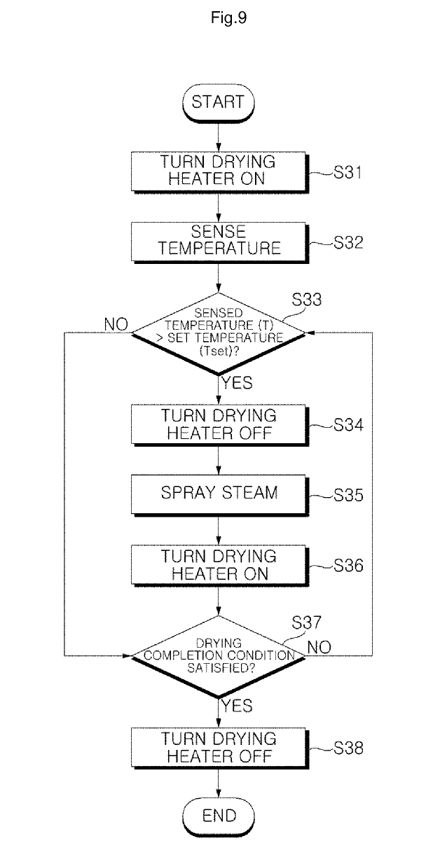

FIG. 9 is a flowchart showing a control method of a dryer according to a further embodiment of the present invention. Referring to FIG. 9, dryer 1 supplies hot air into drum 4 to dry fabric (S31). At step S31, drying heater 42 is operated and blower 22 is rotated. During supply of the hot air, drum 4 may be rotated. At this time, drum 4 may be rotated at a speed at which the fabric can be tumbled.

During supply of the hot air, the temperature of air in drum 4 is sensed by temperature sensor 44 (S32). When a temperature T sensed by temperature sensor 44 is equal to or greater than a set temperature Tset (S33), controller 41 controls the operation of drying heater 42 to be stopped (S34).

A steam spraying step (S35) includes a step of operating steam generation heater 130 in a state in which the operation of drying heater 42 is stopped. The operation of steam generation heater 130 may be performed in a condition that the operation of drying heater 42 is stopped. Since drying heater 42 and steam generation heater 130 are not simultaneously operated but one is operated while the other is not operated, power consumption may be reduced. Consequently, the control operation according to this embodiment may be applied even to a case in which the amount of power supplied to the dryer is not sufficient and thus it is difficult to simultaneously operate drying heater 42 and steam generation heater 130.

After steam is sprayed for a predetermined time at the steam spraying step (S35), controller 41 controls the operation of drying heater 42 to be resumed (S36). The predetermined time may be 10 to 20 seconds; however, the present invention is not limited thereto.

Subsequently, when the drying completion condition is satisfied, the operation of drying heater 42 is stopped and drying of the fabric is completed (S37->S38).

In the above embodiments, when the temperature in drum 4 reaches a predetermined level, steam is supplied into drum 4 to lower the temperature in drum 4. Consequently, it is possible to prevent shrinkage, discoloration, and denaturalization of the fabric due to overheating.

In a case in which input unit 45, for selecting a normal drying mode or a high-temperature drying mode, is provided, the set temperature Tset may have different values based on selected modes at the steam spraying step of each of the embodiments. For example, the set temperature Tset may be about 65° C. in the normal drying mode and about 75° C. in the high-temperature drying mode.

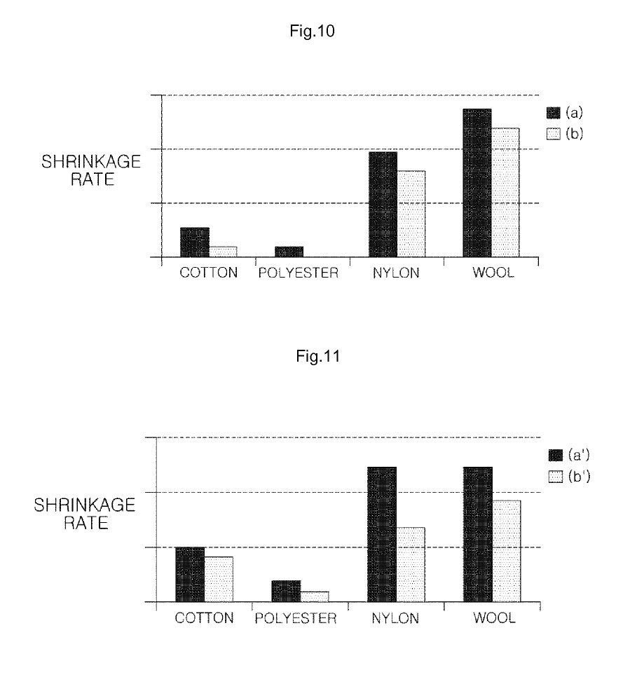

FIG. 10 is a graph showing a comparison between a shrinkage rate (b) of fabric based on materials of the fabric in a normal drying mode of a dryer according to an embodiment of the present invention and a shrinkage rate (a) of fabric in a conventional dryer. FIG. 11 is a graph showing a comparison between a shrinkage rate (b′) of fabric based on materials of the fabric in a high-temperature drying mode of the dryer according to the embodiment of the present invention and a shrinkage rate (a′) of fabric in the conventional dryer.

As can be seen from FIGS. 10 and 11, the control method of the fabric treatment apparatus according to the embodiments of the present invention has a lower shrinkage rate of the fabrics than the control methods of the conventional dryer although the shrinkage rate of the fabric in the normal drying mode (FIG. 10) is different from the shrinkage rate of the fabric in the high-temperature drying mode (FIG. 11). This characteristic is commonly applied to the other embodiments previously described.

Although embodiments have been described herein with reference to a number of illustrative embodiments thereof, it should be understood that numerous other modifications and embodiments can be envisioned by those skilled in the art that will fall within the spirit and scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

What is claimed is:

1. A control method of a fabric treatment apparatus having a drying function, the control method comprising:
supplying, by a drying heater and a blower, high-temperature hot air into a treatment space of the fabric treatment operation, through operation of a drying heater;
sensing, by a temperature sensor, a temperature of the treatment space; and
spraying steam, by a steam spray device, into the treatment space through a steam spray device when the sensed temperature of the treatment space is equal to or greater than a set temperature.

2. The control method of claim 1, wherein the step of spraying the steam comprises spraying the steam for a predetermined time period.

3. The control method of claim 1, wherein the step of spraying the steam comprises intermittently spraying the steam through the steam spray device until a predetermined drying completion condition is satisfied.

4. The control method of claim 3, wherein the step of intermittently spraying the steam comprises spraying the steam for 10 to 20 seconds every 2 to 3 minutes.

5. The control method of claim 1, further comprising:
stopping, by a controller, the operation of the drying heater when the sensed temperature of the treatment space is equal to or greater than the set temperature,
wherein the steam spray device comprises a steam generation heater for generating steam, and
wherein the step of spraying the steam comprises operating the steam generation heater for a predetermined time.

6. The control method of claim 5, further comprising:
stopping, by the controller, the operation of the steam generation heater after a predetermined period of time; and
operating, by the controller, the drying heater again after the operation of the steam generation heater is stopped.

7. The control method of claim 1, wherein the set temperature is about 65° C.

8. The control method of claim 1, wherein the set temperature is about 75° C.

9. The control method of claim 1, wherein the step of supplying hot air comprises operating, by a controller, a blower for blowing air into the treatment space during the operation of the drying heater.

10. The control method of claim 1, wherein
the fabric treatment apparatus comprises a rotatable drum defining the treatment space, and wherein
the step of supplying the hot air comprises rotating, by a motor, the drum such that the fabric is tumbled in the drum.

11. A fabric treatment apparatus comprising:
a treatment space forming unit including a treatment space, in which fabric is treated;
a drying heater for heating air to be supplied to the treatment space;
a blower for blowing the air heated by the drying heater to the treatment space;
a temperature sensor for sensing a temperature of the treatment space;
a steam spray device for spraying steam to the treatment space; and
a controller for controlling the drying heater and the blower to supply high-temperature hot air to the treatment space and for controlling the steam spray device to spray steam when the temperature of the treatment space sensed by the temperature sensor reaches a set temperature.

12. The fabric treatment apparatus of claim 11, wherein the controller controls the steam spray device to spray the steam for a predetermined period of time.

13. The fabric treatment apparatus of claim 11, wherein the controller controls the steam spray device to intermittently spray the steam until a predetermined drying completion condition is satisfied.

14. The fabric treatment apparatus of claim 13, wherein the controller controls the steam spray device to spray the steam for 10 to 20 seconds every 2 to 3 minutes.

15. The fabric treatment apparatus of claim 11, wherein the steam spray device comprises a steam generation heater for generating steam, and
the controller controls the operation of the drying heater to be stopped and the steam generation heater to be operated for a predetermined period of time when the temperature of the treatment space sensed by the temperature sensor reaches the set temperature.

16. The fabric treatment apparatus of claim 15, wherein the controller controls the operation of the steam generation heater to be stopped and the drying heater to be operated again after a predetermined period of time.

17. The fabric treatment apparatus of claim 11, wherein the set temperature is about 65° C.

18. The fabric treatment apparatus of claim 11, wherein the set temperature is about 75° C.

19. The fabric treatment apparatus of claim 11, further comprising:
an input unit for allowing selective input of a normal drying mode or a high-temperature drying mode,
wherein the set temperature when the high-temperature drying mode is selected through the input unit is higher than the set temperature when the normal drying mode is selected through the input unit.

20. The fabric treatment apparatus of claim 11, wherein
the treatment space forming unit comprises a rotatable drum, in which fabric is received, and
wherein the controller controls the drum to be rotated such that the fabric is tumbled in the drum during supplying of high-temperature hot air to the treatment space.
